(19) United States
(12) Patent Application Publication
(10) Pub. No.: US 2014/0339749 A1
(43) Pub. Date: Nov. 20, 2014

(54) ANTI-VIBRATION DEVICE

(71) Applicant: BRIDGESTONE CORPORATION, Tokyo (JP)

(72) Inventor: Akihiro SAITO, Yokohama-shi (JP)

(73) Assignee: BRIDGESTONE CORPORATION, Tokyo (JP)

(21) Appl. No.: 14/276,173

(22) Filed: May 13, 2014

(30) Foreign Application Priority Data
May 15, 2013 (JP) 2013-103552

(51) Int. Cl. F16F 15/08; B60G 11/22

(52) U.S. Cl. CPC F16F 15/08; B60G 11/22
USPC 267/141.1

(57) ABSTRACT

An anti-vibration device (10) is provided with a ring shaped resilient stopper body (30) that is disposed at an outer periphery of a second attachment member (14). The resilient stopper body (30) is clamped between one end of a first attachment member (12) and a vehicle body side plate (20), and is capable of movement relative to the second attachment member (14). Protruding portions (34) are provided to the inner peripheral face of the resilient stopper body (30), and protrude out from the inner peripheral face toward the second attachment member (14).

### CROSS-REFERENCE TO RELATED APPLICATION

This application claims priority under 35 USC 119 from Japanese Patent Application No. 2013-103552, the disclosure of which is incorporated by reference herein.

### TECHNICAL FIELD

The present invention relates to an anti-vibration device that is employed as a member mount or similar in general industrial machines or automobiles, and that absorbs and dampens vibration transmitted from a suspension or similar to a vehicle body.

### BACKGROUND ART

Conventionally, various anti-vibration devices have been proposed that are provided with an outer tube that is coupled to a suspension or similar, an inner tube that is disposed with the same axis at the inside of the outer tube and that is coupled to a vehicle body side member, and a resilient body that couples the inner tube and the outer tube. In anti-vibration devices with this kind of configuration, a stopper rubber, that is a separate body to the resilient body, is sometimes provided at one end of the tube axial direction in order to restrict movement of the outer tube relative to the inner tube (refer to Japanese Patent Application Laid-Open (JP-A) No. 2003-21194). The stopper rubber is normally vulcanization bonded to a plate that is fixed to the inner tube. However, in this case, a process in which the stopper rubber is vulcanization bonded to the plate is required during manufacturing, increasing the number of processes, and also raising the cost.

### SUMMARY OF INVENTION

### Technical Problem

In consideration of the above issue, an object of the present invention is to provide an anti-vibration device equipped with a resilient stopper body that is capable of easy manufacture, and that is capable of exhibiting stable spring properties.

### Solution to Problem

In order to achieve the above object, an anti-vibration device according to a first aspect of the present invention is provided with: a tube-shaped first attachment member that is coupled to one of a vibration generating section side member or a vibration receiving section side member; a second attachment member that is disposed inserted through an inside of the tube of the first attachment member, and that has one end side that is coupled to the other of the vibration generating section side member or the vibration receiving section side member; a resilient body that is disposed between the first attachment member and the second attachment member, and that couples together the first attachment member and the second attachment member; and a resilient stopper body, that is ring shaped, that is clamped between, without being fixed to, the vibration generating section side member and the vibration receiving section side member, that is disposed at an outer periphery of the second attachment member, that is capable of movement relative to the second attachment member, and that has a protruding portion that protrudes out from an inner peripheral face of the resilient stopper body toward the second attachment member.

In the anti-vibration device according to the first aspect, the resilient stopper body is clamped between, without being fixed to, the vibration generating section side member and the vibration receiving section side member, such that the second attachment member and the resilient stopper body are capable of movement relative to each other. Namely that resilient stopper body is not fixed to the second attachment member. The protruding portion is formed protruding from the inner peripheral face of the resilient stopper body toward the second attachment member, enabling positioning in the resilient stopper body radial direction to be easily performed when assembling the resilient stopper body to the second attachment member.

In an anti-vibration device with this kind of configuration, when the first attachment member and the second attachment member are moved relative to each other in a direction orthogonal to the axial direction due to vibration input, the protruding portion provided at the inner peripheral face of the resilient stopper body is pressed by the second attachment member and deforms, and the resilient stopper body and the second attachment member move relative to each other. However, relative movement between the resilient stopper body, that is clamped between the first attachment member and the second attachment member, and the first attachment member is suppressed. The resilient stopper body is thereby retained at a specific position with respect to the first attachment member, enabling the resilient stopper body to be suppressed from bulging out to the radial direction inside or outside of the first attachment member and changing the spring properties. Moreover, the resilient stopper body and the second attachment member are not vulcanization bonded, enabling easy manufacture.

An anti-vibration device according to a second aspect of the present invention includes a recessed space formed between the protruding portion and the inner peripheral face of the resilient stopper body, that accommodates deformation toward a radial direction outer side of the protruding portion.

According to the above configuration, when the first attachment member and the second attachment member move relative to each other in a direction orthogonal to the axial direction due to vibration input, the recessed portion becomes an escape portion, facilitating deformation of the protruding portion, and facilitating relative movement occurring between the second attachment member and the resilient stopper body. This thereby enables the resilient stopper body to be more reliably retained at a specific position with respect to the first attachment member.

In an anti-vibration device according to a third aspect of the present invention, the protruding portion is inclined such that the inclination includes of component along an axial direction of the second attachment member.

The above configuration enables the recessed portion to be easily formed.

In an anti-vibration device according to a fourth aspect of the present invention, the protruding portion is inclined so as to be disposed more toward the one end side of the second attachment member in a direction progressing toward a radial direction inner side.

The above configuration enables smooth fitting over, when the resilient stopper body is being fitted over the second attachment member, without the protruding portion catching.

In an anti-vibration device according to a fifth aspect of the present invention, plural protruding portions are configured so as to be separated in a circumferential direction.

The above configuration enables suppression of transmission of pressing force from the second attachment member, from the protruding portion disposed at a side that is pressed by the second attachment member, to other protruding portion(s). This thereby makes the resilient stopper body less liable to follow movement of the second attachment member, enabling smooth relative movement between a vehicle body side plate, that is coupled to the second attachment member, and the resilient body.

### Advantageous Effects of Invention

The present invention, as explained above, enables provision of an anti-vibration device that is capable of easy manufacture, and that is capable of exhibiting stable spring properties.

### BRIEF DESCRIPTION OF DRAWINGS

FIG. 1 is a cross-section view of an anti-vibration device according to an exemplary embodiment, taken along line I-I in FIG. 3.

FIG. 2 is an exploded cross-section view of the anti-vibration device illustrated in FIG. 1.

FIG. 3 is a cross-section view of the anti-vibration device according to the present exemplary embodiment, taken along line III-III in FIG. 1.

FIG. 4A is an upper face view of a resilient stopper body of the anti-vibration device according to the present exemplary embodiment.

FIG. 4B is a side cross-section view of a resilient stopper body of the anti-vibration device according to the present exemplary embodiment.

FIG. 5 is cross-section view illustrating a state in which vibration is input in a radial direction to the anti-vibration device according to the present exemplary embodiment, as illustrated in FIG. 1.

FIG. 6A to 6C are cross-section views each illustrating a modified example of a resilient stopper body of the anti-vibration device according to the present exemplary embodiment.

FIG. 7 is a cross-section view illustrating another modified example of a resilient stopper body of the anti-vibration device according to the present exemplary embodiment.

### DESCRIPTION OF EMBODIMENTS

Explanation follows regarding an anti-vibration device according to an exemplary embodiment of the present invention, with reference to the drawings.

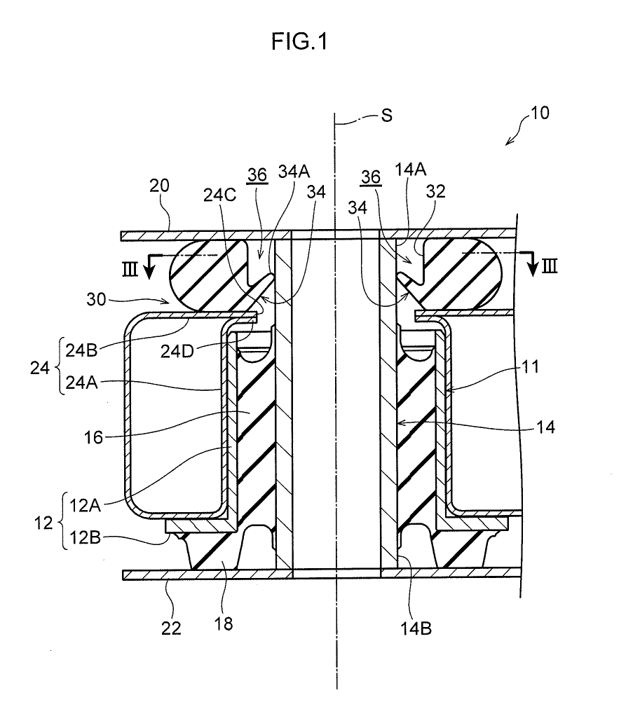

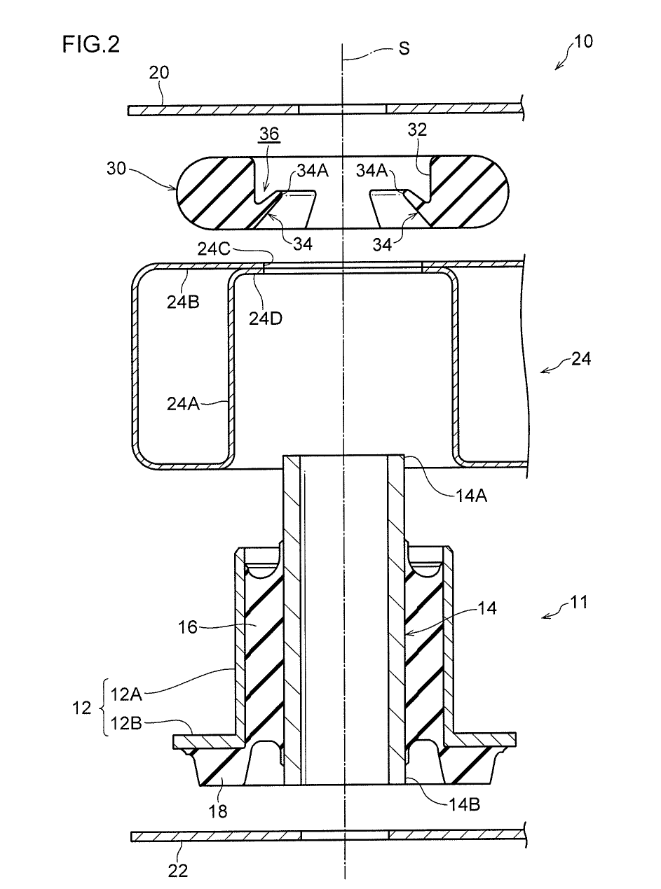

As illustrated in FIG. 1 and FIG. 2, an anti-vibration device 10 according to the present exemplary embodiment is provided with a first attachment member 12, a second attachment member 14, and a rubber resilient body 16. An axial direction of the anti-vibration device 10 is illustrated in FIG. 1 and FIG. 2 by a dotted-dashed line S, that corresponds to the tube axes of the first attachment member 12 and the second attachment member 14.

The first attachment member 12 is provided with a circular tube portion 12A and a flange portion 12B. The circular tube portion 12A has a circular tube shape. The flange portion 12B is formed as a continuation of the circular tube portion 12A so as to extend to the radial direction outside from one end portion of the circular tube portion 12A, to configure a ring shaped plate. The first attachment member 12 may be configured of a metal or a resin, for example. The first attachment member 12 is coupled through a bracket 24 to the vibration generating section side, such as to the suspension.

The bracket 24, that serves as a vibration generating section side member, is coupled to a member on the vibration generating section side such as the suspension, and includes a tube shaped bracket main body 24A and a plate shaped bracket plate 24B. The bracket main body 24A is provided corresponding to the circular tube portion 12A of the first attachment member 12, and the first attachment member 12 is press-fit inside the bracket main body 24A. One end side 24D (a side to which flange portion 12B of the first attachment member 12 is not provided) of the bracket main body 24A protrudes from further along the axial direction S than the circular tube portion 12A, and curves toward the radial direction inside to configure a smaller diameter than the circular tube portion 12A. The bracket plate 24B is joined to the one end side 24D of the bracket main body 24A. The outer diameter of the bracket plate 24B is larger than the outer diameter of the first attachment member 12. Moreover, a hole 24C, through which the second attachment member 14 is capable of being inserted, is formed to the bracket plate 24B. The hole 24C is formed corresponding to the inner diameter of the one end side 24D of the bracket main body 24A, and has an outer diameter that is smaller than the circular tube portion 12A. A plate face of the bracket plate 24B is disposed so as to be orthogonal to the axial direction of the first attachment member 12.

The tube shaped second attachment member 14 is disposed along the axial direction S at an inner peripheral side of the first attachment member 12. The second attachment member 14 is configured such that the length in the axial direction S is longer than that of the first attachment member 12. One end side 14A (a side to which the flange portion 12B of the first attachment member 12 is not provided) of the second attachment member 14 is joined to a vehicle body side plate 20, that serves as a vibration receiving section side member. The vehicle body side plate 20 is plate shaped, with the plate face is disposed so as to be orthogonal to the axial direction of the second attachment member 14, and spatially separated from the first attachment member 12. The second attachment member 14 is coupled to a vehicle body frame, not illustrated in the drawings.

A lower plate 22 is joined to another end side 14B of the second attachment member 14 (a side to which the flange portion 12B of the first attachment member 12 is provided). The lower plate 22 is also plate shaped, with the plate face disposed so as to be orthogonal to the axial direction of the second attachment member 14, and spatially separated from the first attachment member 12.

The rubber resilient body 16 is disposed between an outer peripheral face of the second attachment member 14 and an inner peripheral face of the first attachment member 12. The second attachment member 14 and the first attachment member 12 are resiliently coupled by the rubber resilient body 16. An inner peripheral side of the rubber resilient body 16 is vulcanization bonded to the outer peripheral face of the second attachment member 14, and an outer peripheral side is vulcanization bonded to the inner peripheral face of the first attachment member 12.

A flange rubber portion 18 is formed at an outer side face of the flange portion 12B of the first attachment member 12, so as to protrude from the flange portion 12B in the axial direction S. The flange rubber portion 18 is integrally formed to the rubber resilient body 16, and contacts the lower plate 22. The first attachment member 12, the second attachment member 14, the rubber resilient body 16 and the flange rubber portion 18 are integrated together and configure an anti-vibration device main body 11.

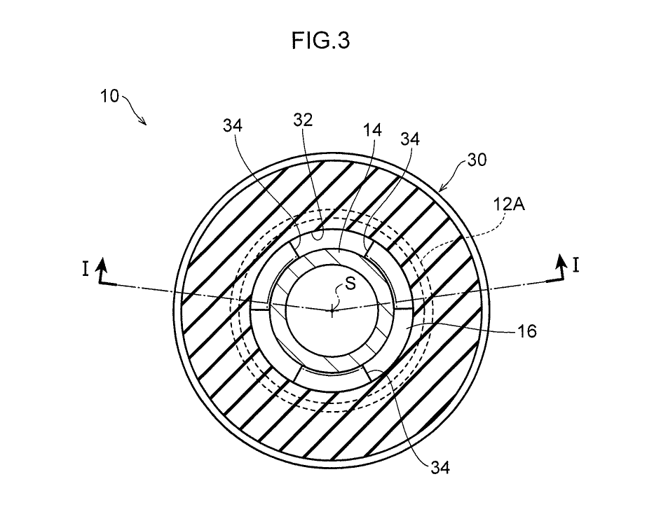

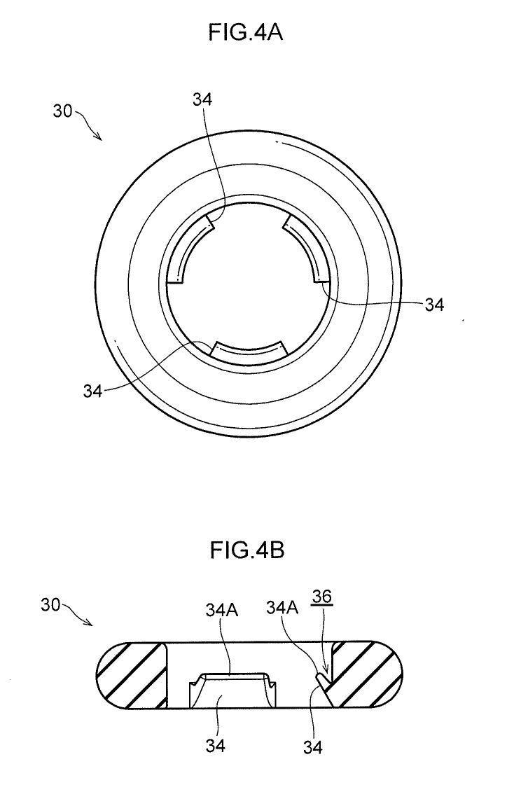

A resilient stopper body 30 is disposed between the vehicle body side plate 20 and the bracket plate 24B. As illustrated in FIG. 3, FIG. 4A and FIG. 4B, the resilient stopper body 30 is ring shaped, and is formed with a central hole 32 through which the second attachment member 14 is capable of being inserted. The central hole 32 has a larger diameter than the hole 24C of the bracket plate 24B. The outer periphery of the resilient stopper body 30 is rounded, such that a portion of the resilient stopper body 30 partway along the axial direction S has the largest diameter. The second attachment member 14 is inserted through the central hole 32 of the resilient stopper body 30, and the resilient stopper body 30 is disposed on the bracket plate 24B. The resilient stopper body 30 is clamped between, without being fixed to, the vehicle body side plate 20 and the bracket plate 24B. The resilient stopper body 30 is formed of a resilient body such as rubber.

Protruding portions 34 are formed at an inner periphery of the resilient stopper body 30. The protruding portions 34 protrude toward the second attachment member 14 from an inner peripheral end portion of the resilient stopper body 30 at the bracket plate 24B side, and are inclined toward the vehicle body side plate 20, such that the inclination includes a component along the axial direction S. Three protruding portions 34 are formed at equal intervals in the circumferential direction. Leading end portions 34A of the protruding portions 34 contact the outer periphery of the second attachment member 14. Recessed spaces 36 are formed between the leading end portions 34A of the protruding portions 34 and the inner peripheral face of the resilient stopper body 30. In other words, the resilient stopper body 30 includes recessed portions between the inner peripheral face and the protruding portions 34.

Assembly of the anti-vibration device 10 with the above configuration is performed as follows.

First, the anti-vibration device main body 11 is press-fit inside the bracket main body 24A from the one end side 14A of the second attachment member 14. Next, the resilient stopper body 30 is fitted over the one end side 14A of the second attachment member 14, and mounted on the bracket plate 24B. When this is being performed, the leading end portions 34A of the protruding portions 34 formed to the resilient stopper body 30 come into contact with the outer periphery of the second attachment member 14, thereby enabling easy positioning in the radial direction. Next, the lower plate 22 is disposed to the other end side 14B of the second attachment member 14, and the vehicle body side plate 20 is disposed on the resilient stopper body 30. Next, bolts, not illustrated in the drawings, are inserted inside the second attachment member 14 tube, and the vehicle body side plate 20 and the lower plate 22 are coupled to the second attachment member 14.

Explanation follows regarding operation of the anti-vibration device 10 according to the present exemplary embodiment.

When vibration in the axial direction S is input from a vibration input side member to the bracket 24, and the second attachment member 14 is displaced upward with respect to the first attachment member 12, the flange rubber portion 18 is pressed against lower plate 22, and excessive movement of the first attachment member 12 relative to the second attachment member 14 is restricted. Moreover, when the second attachment member 14 is displaced downward with respect to the first attachment member 12, the resilient stopper body 30 is pressed against the vehicle body side plate 20, and excessive movement of the first attachment member 12 relative to the second attachment member 14 is restricted.

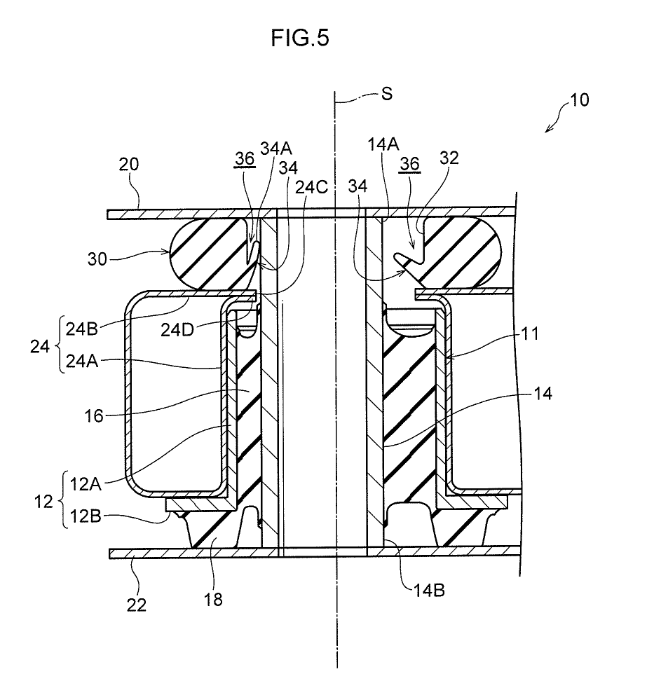

When vibration is input from a vibration input side member to the bracket 24 in the radial direction, and the first attachment member 12 displaces relative to the second attachment member 14 such that the tube axis of the second attachment member 14 is misaligned with respect to the tube axis of the first attachment member 12, as illustrated in FIG. 5, one radial direction side (the left side in FIG. 5) of the rubber resilient body 16 is pressed against the second attachment member 14 and undergoes compressive deformation. When this occurs, the compressed protruding portion 34 bends over and withdraws inside the recessed space 36, thereby making the other radial direction side (the right side in FIG. 5) of the rubber resilient body 16 less liable to move relative to the bracket 24. The resilient stopper body 30 is thereby retained on the bracket plate 24B, enabling the resilient stopper body 30 be suppressed from becoming trapped between the second attachment member 14 and the bracket 24, or from bulging out from the outside of the bracket plate 24B. This enables damage to the resilient stopper body 30, due to being trapped, or bulging out, to be suppressed, enabling impact to the spring properties of the resilient stopper body 30 to be reduced.

Moreover, the resilient stopper body 30 in the present exemplary embodiment does not need to be vulcanization bonded to the vehicle body side plate 20, enabling the resilient stopper body 30 to be manufactured easily and inexpensively

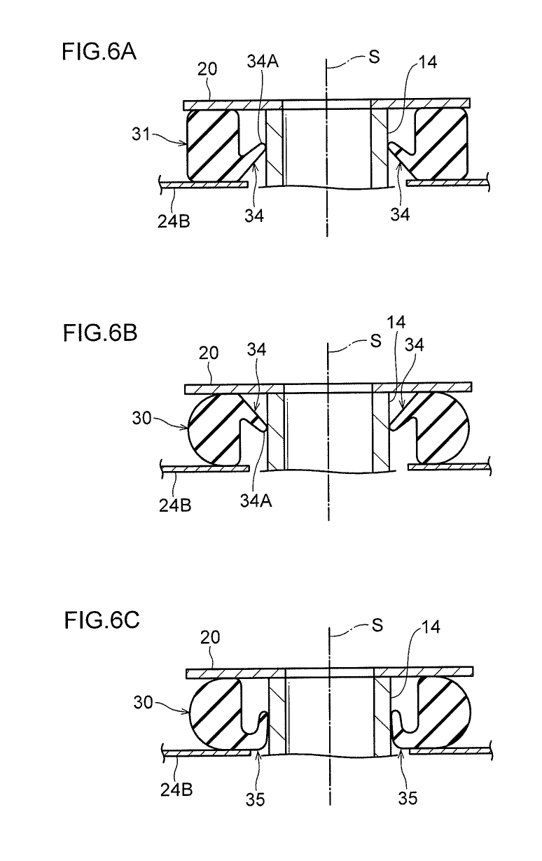

Note that, although a resilient stopper body 30 with a rounded outer periphery is employed in the present exemplary embodiment, a square cross-section shaped resilient stopper body 31 that does not have a rounded outer periphery may also be employed, as illustrated in FIG. 6A.

Moreover, although the protruding portions 34 of the resilient stopper body 30 are provided to the inner periphery of the resilient stopper body 30 on the bracket plate 24B side in the present exemplary embodiment, the protruding portions 34 may also be provided at the center, or at the vehicle body side plate 20 side of the inner periphery of the resilient stopper body 30.

Moreover, although the recessed spaces 36 are formed between the leading end portions 34A of the protruding portions 34 and the outer periphery of the second attachment member 14 in the present exemplary embodiment, the recessed spaces 36 are not essential. As illustrated in the present exemplary embodiment, by providing the recessed spaces 36, deformation toward the inside of the recessed spaces 36 is accommodated when movement of the first attachment member 12 relative to the second attachment member 14 has occurred in the radial direction, facilitating deformation of the protruding portions 34. Relative movement between the second attachment member 14 and the resilient stopper body 30 thereby occurs more easily. This thereby enables a specific position of the resilient stopper body 30 with respect to the first attachment member 12 to be more reliably retained.

Moreover, although in the present exemplary embodiment the protruding portions 34 of the resilient stopper body 30 have tapered shapes with the leading end portion 34A side thereof inclined toward the vehicle body side plate 20, the protruding portions 34 may have tapered shapes that incline toward the bracket plate 24B side, as illustrated in FIG. 6B. As in the present exemplary embodiment, configuring the protruding portions 34 of the resilient stopper body 30 with tapered shapes in which the leading end portion 34A side incline toward the vehicle body side plate 20 enables smooth fitting of the resilient stopper body 30 over the second attachment member 14, without catching of the protruding portions. Moreover, the protruding portions do not necessarily have to be taper shaped; as illustrated in FIG. 6C, protruding portions 35 may be configured with hook shaped cross-sections. Configuring the protruding portions with tapered shapes as in the present exemplary embodiment enables recessed spaces to be formed easily between the protruding portions and the outer face of the second attachment member 14.

Moreover, although an example has been explained in the present exemplary embodiment in which three protruding portions 34 are formed at equal intervals in the circumferential direction, there may be two, or four or more protruding portions. Moreover, although in the present exemplary embodiment the protruding portions 34 are formed divided in the circumferential direction, a protruding portion may be formed so as to span continuously around the entire circumferential direction. Configuring the protruding portions as divided in the circumferential direction, as in the present exemplary embodiment, enables suppression of transmission of pressing force from the second attachment member 14 across from the protruding portion at the side pressed by the second attachment member 14 to other protruding portion(s). This makes the resilient stopper body 30 less liable to follow the movement of the second attachment member 14, enabling smooth movement of the vehicle body side plate 20 coupled to the second attachment member 14 relative to the resilient stopper body 30.

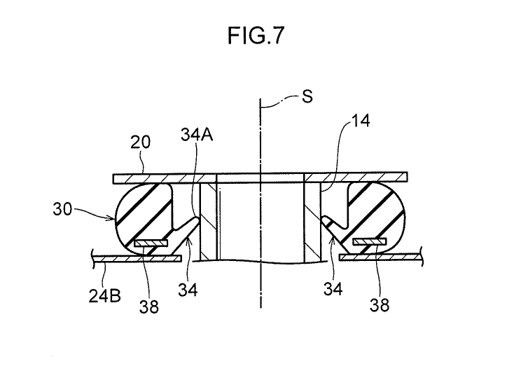

Moreover, as illustrated in FIG. 7, a ring shaped insert fitting 38 may be embedded in the resilient stopper body 30. The insert fitting 38 enables the strength of the resilient stopper body 30 to be increased.

Moreover, although an example has been explained in the present exemplary embodiment in which the resilient stopper body 30 is disposed on the bracket plate 24B, the bracket plate 24B not essential, and the resilient stopper body 30 may be disposed on the bracket main body 24A. Moreover, in cases in which the circular tube portion 12A of the first attachment member 12 is large in diameter, the resilient stopper body 30 may be disposed in direct contact with one end side of the circular tube portion 12A.

1. An anti-vibration device, comprising:
a tube-shaped first attachment member that is coupled to one of a vibration generating section side member or a vibration receiving section side member;
a second attachment member that is disposed inserted through an inside of the tube of the first attachment member, and that has one end side that is coupled to the other of the vibration generating section side member or the vibration receiving section side member;
a resilient body that is disposed between the first attachment member and the second attachment member, and that couples together the first attachment member and the second attachment member; and
a resilient stopper body, that is ring shaped, that is clamped between, without being fixed to, the vibration generating section side member and the vibration receiving section side member, that is disposed at an outer periphery of the second attachment member, that is capable of movement relative to the second attachment member, and that has a protruding portion that protrudes out from an inner peripheral face of the resilient stopper body toward the second attachment member.

2. The anti-vibration device of claim 1, wherein a recessed space is formed, between the protruding portion and the inner peripheral face of the resilient stopper body, that accommodates deformation toward a radial direction outer side of the protruding portion.

3. The anti-vibration device of claim 2, wherein the protruding portion is inclined such that the inclination includes a component along an axial direction of the second attachment member.

4. The anti-vibration device of claim 3, wherein the protruding portion is inclined so as to be disposed more toward the one end side of the second attachment member in a direction progressing toward a radial direction inner side.

5. The anti-vibration device of claim 1, wherein a plurality of the protruding portions are configured so as to be separated in a circumferential direction.
